(19) United States
(12) Patent Application Publication
(10) Pub. No.: US 2005/0185092 A1
(43) Pub. Date: Aug. 25, 2005

(54) Flicker Reduction System for Displaying Web Pages on Television

(76) Inventor: Akio Tanaka, Oakland, CA (US)

Correspondence Address: AKIO TANAKA, 1019 HARVARD ROAD, OAKLAND, CA, 94610, US

(21) Appl. No.: 10/908,501

(22) Filed: May 14, 2005

(51) Int. Cl. H04N 11/20

(52) U.S. Cl. 348/447; 348/910

(57) ABSTRACT

A flicker reduction system for displaying web pages on an interlaced television is provided. Under the control of a browser, the browser analyzes the web page objects with horizontal edges to determine if the flicker conditions are present. If flicker conditions exist, a horizontal edge may be moved to a different field in the interlaced display, so that high contrast horizontal edge can be displayed without flicker and loss of resolution.

### BACKGROUND OF THE INVENTION

The present invention is related to techniques for reducing flicker on an interlaced television display and, in particular, to techniques for reducing flicker in World Wide Web pages displayed on a television monitor.

One of the most significant technological advances in the last decade has been the emergence of the Internet. To further popularize the World Wide Web, some companies, such as MSN TV of Mountain View, Calif., have developed devices so that the web pages can be displayed on a television monitor.

An annoying problem with the display of the computer-generated images like the web page on an interlaced television monitor is flicker. In an interlaced television, a display is separated into two sets of alternating fields that comprise a frame. Flicker occurs when two high contrast horizontal edges, which are close to each other, occupy two different fields on the interlaced television monitor. In normal video, the interlace flicker is not a problem because there are few high contrast horizontal edges in the picture. However, computer-generated graphics such as those found on a web page have many such horizontal edges.

Some of the prior art tried to reduce flicker by filtering the picture or by doubling the scan lines.

U.S. Pat. No. 5,959,680 discloses a system that reduces flicker by filtering the pixel data representing network data.

U.S. Pat. No. 6,014,182 discloses a system that removes flicker by doubling the number of scan lines.

The disadvantages of these methods are that filtering reduces the resolution of the displayed image and doubling the scan line requires the expense of additional hardware.

Another prior art that is disclosed in a series of three patents tries to avoid reducing the overall resolution of the whole display by selectively filtering certain objects.

U.S. Pat. No. 5,745,909 describes a method where a special tag is used to identify images to be filtered.

U.S. Pat. No. 6,173,296 describes a method where spatial analysis is done on images, and the images that have a coherent high frequency component in the vertical dimension are filtered.

U.S. Pat. No. 6,539,407 describes a method where spatial analysis is done on both images and non-image objects to identify objects with coherent high frequency components in the vertical dimension.

The above three patents are based on the premise that flicker is caused by objects with coherent high frequency components in the vertical dimension that are displayed on an interlaced display. They reduce the flicker by filtering objects that have been identified as having a coherent high frequency component in the vertical dimension.

However, the premise that flicker is caused by objects with coherent high frequency components in the vertical dimension is incorrect. A display can have many objects with coherent high frequency components in the vertical dimension without having flicker. For instance, if a display consists of nothing but black horizontal bars with an odd number of scan lines, including single scan lines, and if the black horizontal bars are all separated by a white background with an odd number of scan lines, then the display will not flicker even though all of the horizontal bar objects have a high frequency component in the vertical dimension. Furthermore, filtering such objects can actually result in objects with reduced vertical resolution that flicker. Thus, a flicker reduction method that detects and filters objects with coherent high frequency components in the vertical dimension prevents the displaying of high contrast horizontal edges that do not flicker and unnecessarily reduces the resolution of objects with coherent high frequencies in the vertical dimension that do not flicker.

One example of a device providing the display of images with coherent high frequency components in the vertical dimension without flicker is U.S. Pat. No. 5,943,036 of Tanaka. (“036 patent”). The '036 patent describes a system where the graphic field is divided into odd and even fields corresponding to the interlaced fields. By keeping the neighboring horizontal edges in the same field, it allows for high contrast edges of computer-generated graphics to be displayed without flicker. The '036 patent is hereby incorporated by reference as background material for the device described and claimed herein.

As taught in the '036 patent, two neighboring horizontal edges that are placed in different fields of an interlaced display are perceived by a human observer to be flickering. Because flicker is annoying when viewed for a long time, it is desirable to reduce it.

The '036 patent allows for flicker-free display in a computer system where the operating system or application software can provide objects whose neighboring horizontal edges are constrained to one selected field. However, web pages that are downloaded to a computer do not limit the horizontal edges of display objects to one particular field. Since the web page designer posts a single web page that can be displayed on any platform, restricting the horizontal edges to occupy the same field is undesirable. Hence, there is a need for a technique for displaying web page objects with a high coherent frequency component in the vertical dimension without flicker and without reducing the resolution of the objects.

### SUMMARY OF THE INVENTION

The present invention provides for a method of processing web page objects that might cause flicker on the interlaced television monitor of a computer system. This method includes the steps of selecting a field to display the horizontal edges; checking for objects in the web page that have horizontal edges; determining if the horizontal edges of each of the objects can be placed in the selected field; and placing the horizontal edges of the objects in the selected field.

The present invention also provides for a method of modifying the object if all of the horizontal edges cannot be placed in the selected field. This method includes a step of modifying the position of the horizontal edges so that all of the edges can be placed in the selected field; modifying the intensity value of the horizontal edges of the object that cannot be placed in the selected field; or applying a filter to the object to reduce the flicker.

The present invention also provides for a method for placing text objects on the interlaced television monitor to reduce flicker. The method includes the steps of selecting a field to display horizontal edges; checking for objects in the web page that have text; determining the position of the baseline from the text attributes; and placing the baseline and underline of the text objects on the selected field so that the flicker of the text is reduced.

The present invention also provides for a computer system connected by a communications link to the Internet. This computer system has a television display of two interlaced fields and browser software processing web page instructions for placing web page objects from the Internet onto the television display. The browser checks each of the objects in the web page to see if they have any horizontal edges and places the horizontal edges in one predetermined field so that the flicker of the object is reduced. If the browser software determines that all of the horizontal edges of an object cannot be placed on the selected field, then the browser software can modify the position of the horizontal edges so that all of the edges can be placed on the selected field, change the intensity of the horizontal edges that can not be placed in the selected field, or filter the object to reduce the flicker.

Furthermore, the present invention provides for a computer system as described above with browser software processing web page instructions for placing text on the television display. The browser checks the web page for objects with text, determines the position of the baseline from the text attributes, and places the baseline and underline of the text objects on the selected field so that the flicker of the text object is reduced.

### BRIEF DESCRIPTION OF THE DRAWINGS

FIG. 1 illustrates an exemplary computer system and its generalized connection to an Internet server and which system is capable of reducing flicker of objects in a web page on an interlaced television display in accordance to an embodiment of the present invention;

FIG. 2 shows a flowchart of steps in the operation of the FIG. 1 computer system browser software for processing web page objects to reduce flicker in the television monitor;

FIG. 3 is a detail of the display on the FIG. 1 monitor that illustrates the position of the two objects if the original specified height and position were not modified;

FIG. 4 is a detail of the display on the FIG. 1 monitor that illustrates the position of the two objects of FIG. 3 after the browser modified the height and position according to one embodiment of the present invention;

FIG. 5 is a detail of the display on the FIG. 1 monitor that illustrates the position of the object with multiple height attributes if the original height attributes were not modified;

FIG. 6 is a detail of the display on the FIG. 1 monitor that illustrates the position of the object of FIG. 5 after the browser modifies the multiple height attributes according to one embodiment of the present invention;

FIG. 7 is a detail of the display on the FIG. 1 monitor that illustrates how the baseline and underline of a text object is analyzed as a horizontal edge;

FIG. 8 is a detail of the display on the FIG. 1 monitor that illustrates the position of the two objects of FIG. 3 if the intensity value of the horizontal edges has been modified according to a second embodiment of the present invention; and

FIG. 9 is a detail of the display on the FIG. 1 monitor that illustrates how the horizontal edges of dark objects on a light background and the horizontal edges of light objects on a dark background are placed by both embodiment of the present invention.

### DETAILED DESCRIPTION OF THE INVENTION

The browser processes the web page instructions to create a displayable web page on the local computer and then displays the web page on the interlaced television raster. The following coordinate is used in the description. The top left corner of the display raster corresponds to the top left corner of the web page with coordinates (x, y)=(0, 0). Moving to the right corresponds to increasing positive x value, while moving down corresponds to increasing positive y value. The display raster consists of two fields: the first field is designated f1 and the second field is designated f2. The odd lines in the web page are displayed on the first field, f1, and the even lines in the web page are displayed on the second field, f2. Placing a horizontal edge on the second field of the television raster corresponds to placing the horizontal edge in one of the even numbered lines of the web page.

Normally, the web page is larger than the displayed raster so that the web page image is scrolled to view the entire web page. By scrolling the web page by an even number of lines, the mapping of the odd numbered lines in the web page to the first field of the display, f1, and the even numbered lines in the webpage to the second field of the display, f2, is preserved. In the following examples, the second field, f2, is chosen by the computer system's browser software to place and display the horizontal edges of dark objects on light background.

The following description uses the case of horizontal edges of dark objects on a light background interacting to cause flicker. However, horizontal edges of light objects on a dark background also interact to cause flicker. The same method is used to analyze and place horizontal edges of light objects on a dark background. If the browser selects one field to display both the horizontal edges of dark objects on light background and the horizontal edges of light object on dark background, there might be some flicker at the boundary between light and dark backgrounds. In the preferred embodiment, the browser selects the horizontal edges of dark objects on light background to be placed on the second field, f2, and the horizontal edges of light objects on dark background to be placed on the first field, f1.

The browser can also set the threshold for determining the difference in luminance intensity between a horizontal edge of an object and the background that will contribute to flicker. If the difference in luminance intensity between the horizontal edge of an object and the background is below the threshold then the horizontal edge of the object is not analyzed for placement on one particular selected field.

The height and position attributes can be specified by different instructions and with different parameters. For example, the height and position attributes can be specified by a HTML tag, style sheet, or by a graphic application running inside a web page. The height and position values can be specified by a pixel value, percentage of a web page, physical measure such as inches and millimeters, or by points, which are used with text. The following description will use the equivalent number of horizontal lines that the browser calculates from the original specified value as the value of the height attribute, which is usually the same as the height in the number of pixels. Also, some height attributes are implicit such as “border” and “size” attributes. The following description will use the height attribute to include all implicit height attributes of an object.

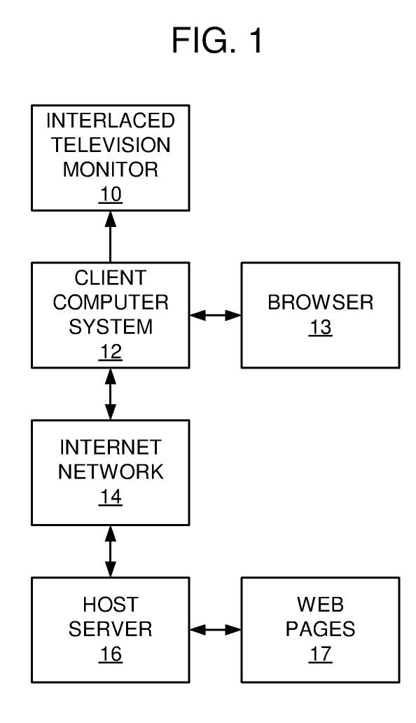

FIG. 1 is an exemplary computer system 12 that is connected to an interlaced television monitor 10. By a communications link, such as a telephone modem, a cable modem, a DSL line, or an optical fiber, the computer system 12 is connected through the Internet network 14 to a particular Internet host server 16. The server 16 hosts a website in the World Wide Web which is being viewed by the user of the computer system 12 through the interlaced television monitor 10. The host server 16 hosts one or more web pages 17 of a website and each web page is formed by a set of instructions in a markup language like HTML and XML. The computer system 12 has a network interface and an internal processor under the control of browser system software 13 that retrieves a web page from the server 16 and displays the web page according to its web page instructions on the interlaced television monitor 10.

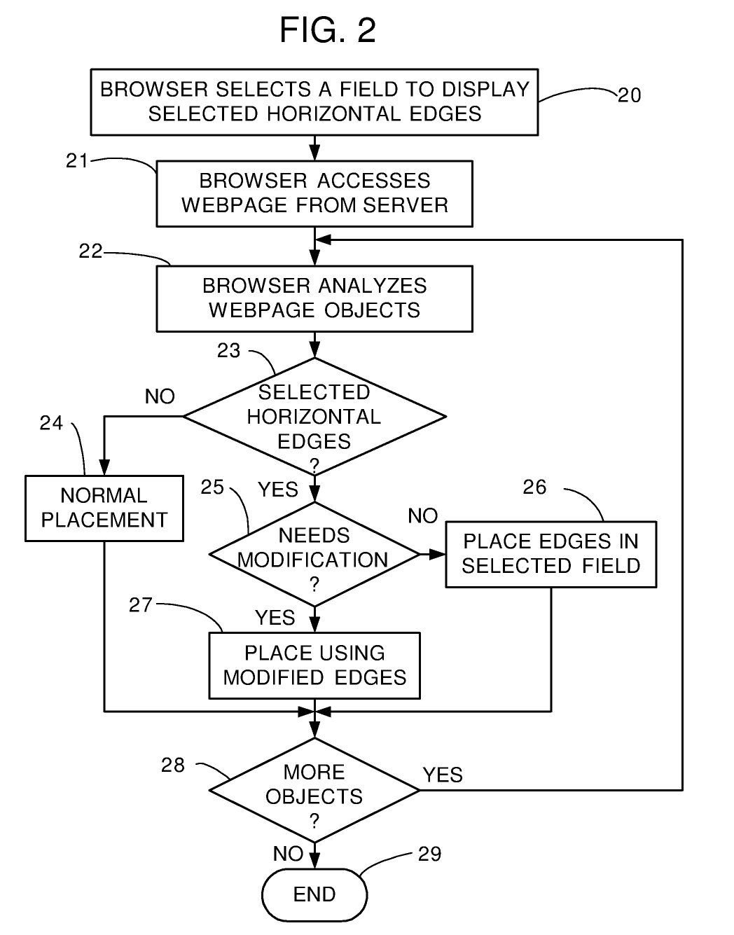

The flow diagram in FIG. 2 illustrates the method of processing web page instructions in a web page. The computer system's browser software selects the horizontal edges of dark object on a light background to be placed on the second fields, f2, and the horizontal edges of light objects on a dark background to be placed on the first field, f1, at step 20.

The browser accesses a web page from the host server at step 21. The browser software analyzes each instruction in the web page at step 22 for display objects, and the object to be displayed is checked at step 23 to determine whether the object has one or more selected horizontal edges that might cause flicker. If the display object has no selected horizontal edges, the browser places the object using the normal placement at step 24. The presence of selected horizontal edges in a non-image object is determined by the object attributes that will result in a horizontal edge such as height attribute or text, since the baseline of the text can act as a horizontal edge. For image objects the presence of a selected horizontal edge can be determined by spatial analysis, which is well known in the art. If the object has one or more selected horizontal edges, the browser software checks to determine whether all of the selected horizontal edges can be placed in the selected field. If it can, then the object is placed in the webpage with the selected horizontal edges on the selected field at step 26.

If all of the selected horizontal edges cannot be placed in the selected field then the one or more of the selected horizontal edges of the object are modified to reduce the flicker. In step 27 the browser modifies the object depending on the type of object.

One method is to change the position of one or more of the selected horizontal edges so that all of the selected horizontal edges can be placed in the same field. In one embodiment of the invention, if one or more height attribute of an object is an even number of lines then the height attribute is changed to an odd number of lines then all the selected horizontal edges are placed in the selected field.

In another embodiment of the invention, if the browser software chooses not to modify the position of the selected horizontal edges of the object, the browser software can reduce flicker by modifying the luminance intensity of the selected horizontal edge that can not be placed on the selected field, or the browser software can apply a flicker reduction filter to the object before placing the object on the display. At step 28 the browser checks if there are more objects to be processed in the web page and repeats the process until all of the objects have been processed and ends at step 29.

The modification and placement of objects on the web page to reduce flicker is illustrated by the following example of HTML code and inline style sheet, which specifies both the height and positioning of the objects.

<HTML>
<HEAD>
<TITLE> Height and Position Attributes Example </TITLE>
</HEAD>
<BODY>
<HR STYLE = “position: absolute; top:
12px” SIZE=“4” NOSHADE WIDTH= “17”

ALIGN=“left”>

<HR STYLE = “position: absolute; top:
21 px” SIZE=“4” NOSHADE WIDTH= “17”

ALIGN=“left”>

</BODY>
</HTML>

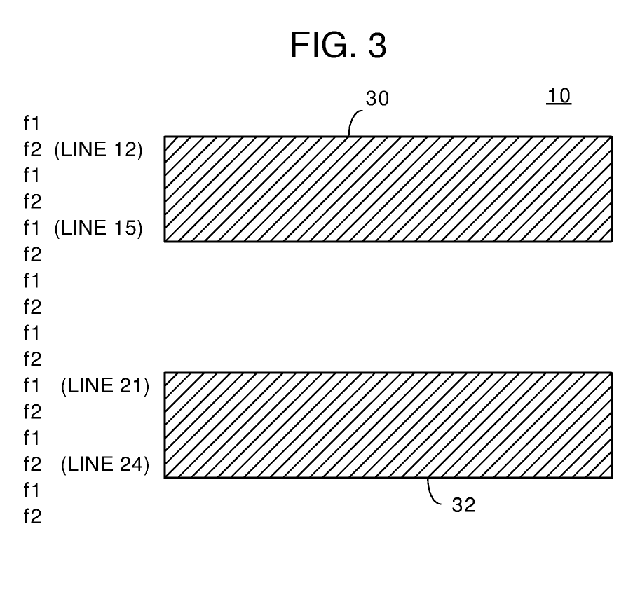

This sample HTML code specifies two objects with both a height and position attribute on a web page. The horizontal line tag <HR> specifies a “horizontal rule” object 30 with a height attribute of 4 lines placed 12 lines down from the top of the page. The second horizontal rule tag <HR> specifies a “horizontal rule” object 32 also with height attribute of 4 lines placed 21 lines down from the top of the page. A general appearance of the resulting web page as displayed on television monitor 10 is shown in FIG. 3. The two horizontal edges of “horizontal rule” object 30 are in different fields so they will interact to cause flicker. Similarly, the two horizontal edges of “horizontal rule” object 32 will also interact to cause flicker.

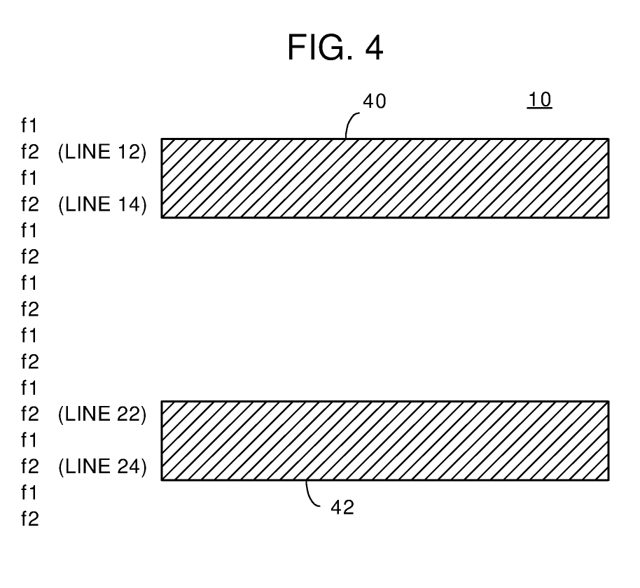

FIG. 4 shows how the two objects in FIG. 3 are modified by the present invention before being displayed on the television monitor 10. The first object 30 which had the height attribute of 4 lines, which is an even number, is changed to an object 40 with height attribute of 3 lines, which is an odd number. The placement of the object is in agreement with the field chosen to display the selected horizontal edges, so the position attribute is kept at line 12. The second object 32 also had the even number of lines for the height attribute so it is changed to an object 42 with odd number of lines. The second object was initially positioned at line 21 on the first field, f1, which is not the selected field, f2, so it is moved to line 22, which is in the selected field, f2. Both objects have been modified and placed so that all of the selected horizontal edges are displayed on the selected field to reduce the interlace flicker.

Above example uses the absolute positioning of objects, and the same procedure is used to analyze relative positioning of objects.

Some objects will have several height attributes. For instance, an object with a border will have a height attribute of the object and a border attribute for the border around the object. In order to avoid flicker both the height of the border and the height of the object must have an odd number of lines and the selected horizontal lines of the object must be placed on the selected field.

The placement of an object that has multiple height attributes is illustrated by the following example of HTML code, which specifies the height of an image object and the height and width of the borders around the object.

<HTML>
<HEAD>
<TITLE> Multiple Height Attribute Example </TITLE>
</HEAD>
<BODY>
<IMG BORDER=4 HEIGHT=8 WIDTH=14>
</BODY>
</HTML>

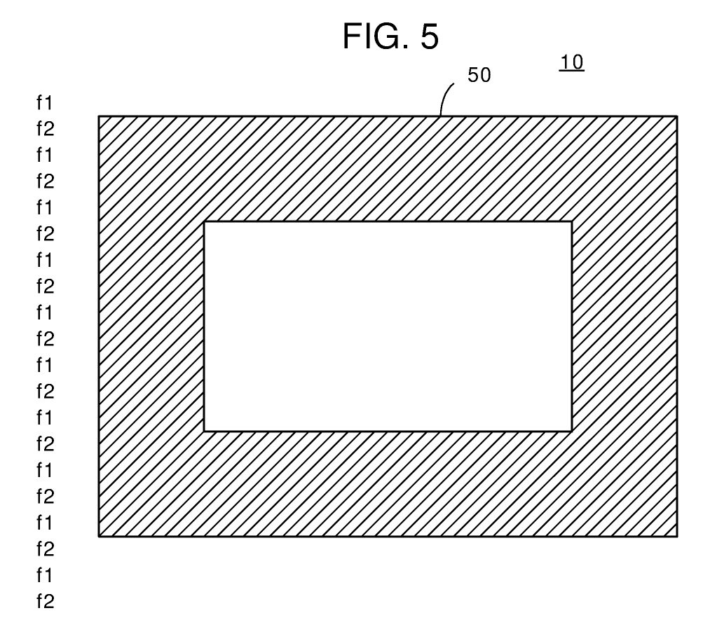

This sample HTML code specifies an image object 50 with a height attribute of 8 lines and a border attribute with height of 4 lines. A general appearance of the resulting web page as displayed on the television monitor 10 is shown in FIG. 5. The two horizontal edges of the top border, the two horizontal edges of the bottom border, and the two adjacent inner horizontal edges of the top and bottom borders are all respectively in different fields, so the object will pulsate with flicker.

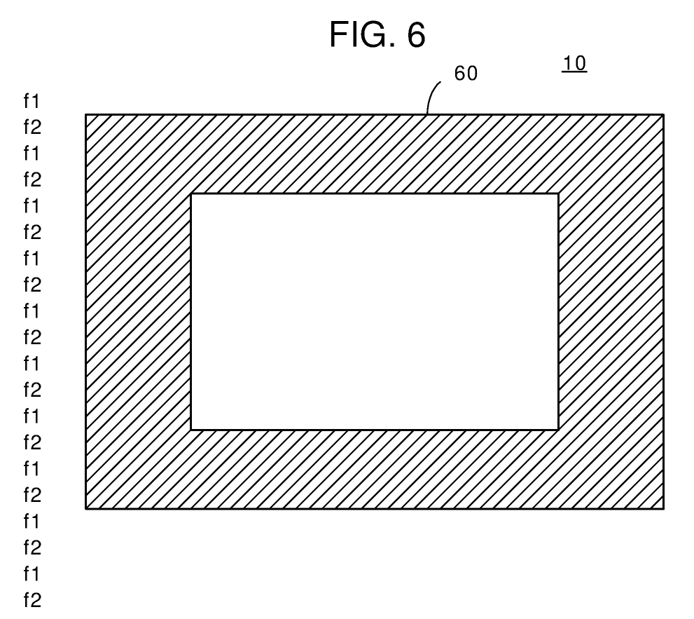

FIG. 6 shows the general appearance of the web page on the television monitor 10 after the object 50 is modified by the present invention. The object 60 which had a height attribute of 8 lines is changed to odd number 9. The border attribute that had a height of 4 lines is changed to odd number 3. The selected horizontal edges are placed in the web page on the selected field. The object with multiple height attributes has been modified and placed so that all of the selected horizontal edges are placed in the web page to be displayed on the selected field to reduce the interlace flicker.

In accordance with first embodiment of the present invention, the browser software 13 in the computer system 12 selects one of the fields to place the horizontal edges of dark objects on light background and selects the other field to place all of the horizontal edges of light object on dark background to reduce flicker on the interlaced display 10. It also analyzes each of the web page display objects and any associated style to see if they have attributes that produce horizontal edges such as the height attribute. If the height and position attributes of an object place the object in a web page such that one or more selected horizontal edges of the object occupies a different field, the height and position value of the object is changed so that all of the selected horizontal edges are in the selected field.

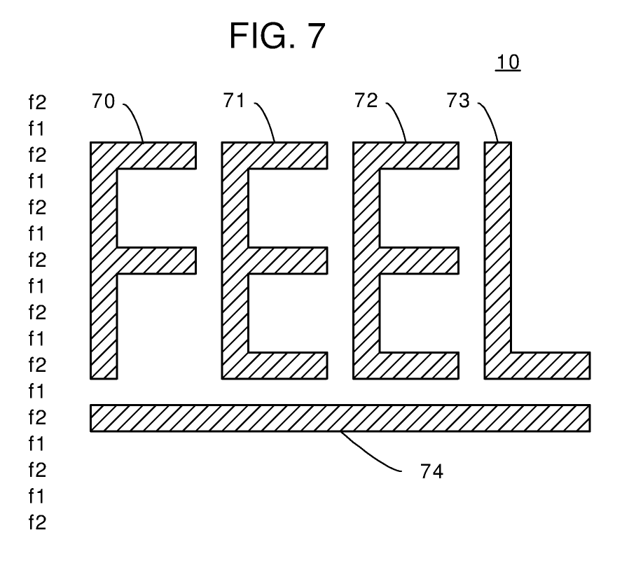

Depending on the font type, such as serif font, the top and baseline of text can act as a horizontal edge so that height and position of the text needs to be treated in the same way as normal horizontal edges. In the case of the text, the height of interest is the vertical distance between the top of the text and the baseline. The browser software 13 in the computer system 12 analyzes the text objects to determine the position of the baseline and the height of the text. It places the baseline of the text in the field selected to display selected horizontal edges and changes the height of the text if it will contribute to flicker. FIG. 7 shows general appearance of the displayed text on the television monitor 10 showing that baseline and top of the text, consisting of letters 70, 71, 72 and 73, are placed in the selected field and underline, 74, is also placed in the selected field.

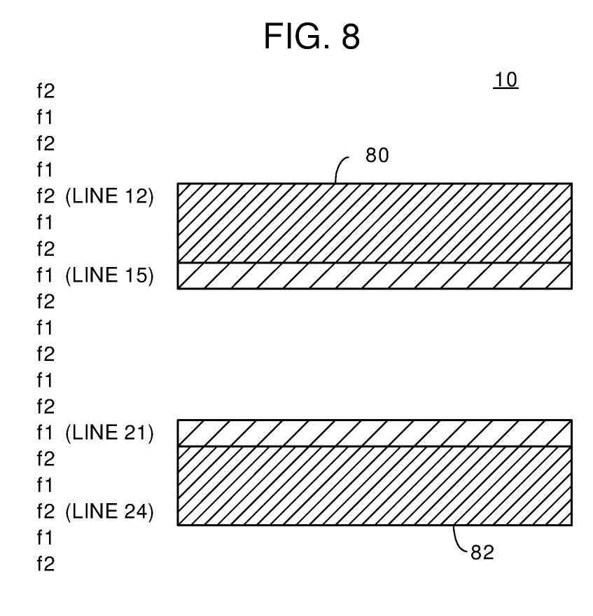

The first embodiment is meant to allow for display of objects with high coherent spatial frequency in the vertical dimension without flicker. The browser software can also reduce flicker by changing the luminance intensity of the selected horizontal edge that is not on the selected field. FIG. 8 shows general appearance of the two objects, 80 and 82, on the television monitor 10, which are the objects 30 and 32 of FIG. 3 after the browser has modified them by changing the luminance intensity of the selected horizontal edges that are not in the selected field.

In accordance with second embodiment of the present invention, the browser software selects one of the fields in which the horizontal edges of dark objects on light background are placed and selects the other field in which the horizontal edges of light object on dark background are placed to reduce flicker on the interlaced display 10. It also analyzes each of the display objects to see if they have horizontal edges that can contribute to flicker. For display objects that do not have explicit or implicit height attribute, the locations of the horizontal edges are determined by spatial analysis. If the selected horizontal edges of an object can all be placed on the selected field, they are placed on the selected field. If all of the selected horizontal edges of the object cannot be placed on the selected field then the object is modified to reduce flicker by moving selected horizontal edges, which is not on the selected field, onto the selected field; by changing the luminance intensity of the selected horizontal edges that cannot be placed on the selected field; or applying a flicker reduction filter on the object.

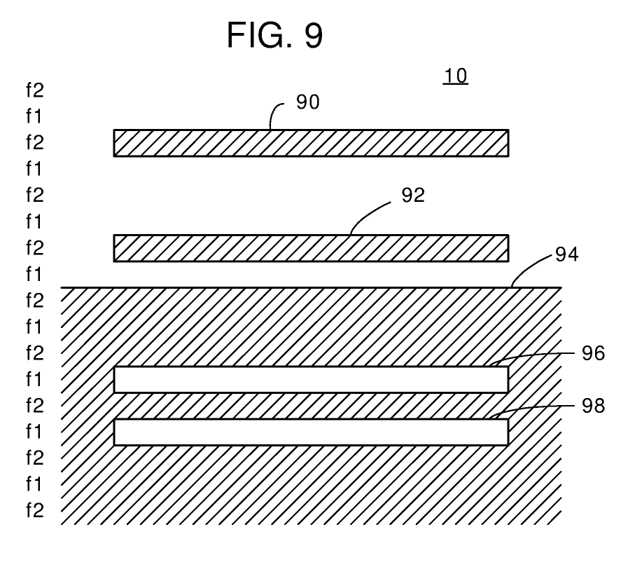

FIG. 9 shows the general appearance of the television monitor 10 when both horizontal edges of dark object on light background and horizontal edges of light object on dark background are displayed on the same display. The browser places the two dark objects, 90 and 92, on the light background on the second field, f2. The browser also places the two light objects, 96 and 98, on the dark background 94 on the first field, f1.

While the above is a complete description of the specific exemplary embodiment of the invention, various alternatives, modifications and equivalents may be used. It should be evident that the present invention is equally applicable by making appropriate modifications to the embodiment described above. Therefore, the above description should not be taken as limiting the scope of the invention which is defined by the metes and bounds of the appended claims.

1. In a computer system having a display of two interlaced fields, a method of reducing flicker of objects in a webpage on said display, the method comprising steps of:
selecting a field of said display to display selected horizontal edges of said plurality of objects;
analyzing each one of said plurality of objects to determine which objects have one or more height attributes;
determining a number of lines for each one of said one or more height attributes;
modifying said number of lines to an odd number if said number of lines is even; and
placing said selected horizontal edges of said objects that have said one or more height attribute in said webpage on the selected field whereby the flicker is reduced.

2. The method of claim 1, wherein said height attributes includes a markup language height attribute.

3. The method of claim 1, wherein said height attributes includes implicit height attribute.

4. The method of claim 1, wherein said selected horizontal edges includes baseline of text.

5. The method of claim 1, wherein said selected horizontal edges includes underline of text.

6. The method of claim 1, wherein said height attributes includes a height between baseline and top of text.

7. The method of claim 1, further comprising the step of selecting a horizontal edge of the object if the horizontal edge is darker than the background luminous intensity.

8. The method of claim 1, further comprising the step of placing the horizontal edges of the objects that are lighter than the background luminous intensity to the other field of the interlaced display.

9. In a computer system having a display of two interlaced fields, a method of reducing flicker of objects in a webpage on said display, the method comprising the steps of:
selecting a field of said display to display selected horizontal edges of said plurality of objects;
analyzing each one of said plurality of objects to determine which objects have said selected horizontal edges that can all be placed on the selected field unmodified and which objects have said selected horizontal edges that cannot all be placed on the selected field;
placing said selected horizontal edges of said plurality of objects, which have said selected horizontal edges that can all be placed on said selected field unmodified, in said webpage on said selected field; and
modifying each one of said plurality of objects, which have said selected horizontal edges that cannot all be placed on said selected field, whereby the flicker is reduced.

10. The method in claim 9, wherein the said modification step includes the steps of:
changing the placement of one or more of said selected horizontal edges of the object that cannot be placed on said selected field, so that all of said selected horizontal edges can be placed on the said selected field; and
placing all of the said selected horizontal edges of said object in said webpage on said selected field.

11. The method of claim 10, wherein the changing step includes steps of:
checking said object to determine if it has one or more height attributes;
determining a number of lines for each one of said height attributes of said object; and
modifying said number of lines to an odd number if said number of lines is even.

12. The method of claim 11, wherein said height attributes includes an implicit height attribute.

13. A method of claim 11, wherein said height attributes includes a markup language height attribute.

14. A method of claim 9, wherein the said modification step includes the steps of:
modifying a luminance intensity of each one of said selected horizontal edges of the object that cannot be placed on the selected field;
placing said selected horizontal edges of said object that has not been modified in said webpage on said selected field; and
placing said selected horizontal edges of said object with modified luminance intensity in said webpage on the other field of the interlaced display.

15. The method of claim 9, wherein the said modification step includes the steps of:
applying a flicker reduction filter to reduce the flicker of the object; and
placing the filtered object in the webpage on the interlaced display.

16. The method of claim 9, wherein said selected horizontal edges includes baseline of text.

17. The method of claim 9, wherein said selected horizontal edges includes underline of text.

18. The method of claim 9, wherein said height attributes includes a height between baseline and top of text.

19. The method of claim 9, further comprising the step of selecting a horizontal edge of the object if the horizontal edge is darker than the background luminous intensity.

20. The method of claim 9, further comprising the step of placing the horizontal edges of the objects that are lighter than the background luminous intensity to the other field of the interlaced display devise.

21. A computer system connected by a communications link to the Internet, said computer system having:
a display of two interlaced fields; and
browser software processing webpage instructions for placing webpage from the Internet on said display, said browser:
selects a field of said display to display selected horizontal edges of said plurality of objects;
analyzes each one of said plurality of objects to determine which objects have one or more height attributes;
determines a number of lines for each of said one or more height attributes;
modifies said number of lines to an odd number if said number of lines is even; and
places said selected horizontal edges of said objects that have said one or more height attribute in said webpage on the selected field whereby the flicker is reduced.

22. The computer system in claim 21, wherein said selected horizontal edges includes baseline of text.

23. The computer system in claim 21, wherein said selected horizontal edges includes horizontal edges of text underline.

24. The computer system in claim 21 wherein said height attributes includes a height between baseline and top of text.

25. The computer system in claim 21, wherein the said browser further selects a horizontal edge of the object if the horizontal edge is darker than the background luminous intensity.

26. The computer system in claim 21, wherein the said browser further places the horizontal edges of the objects that are lighter than the background luminous intensity to the other field of the interlaced display devise.

27. A computer system connected by a communications link to the Internet, said computer system having:
a display of two interlaced fields; and
browser software processing webpage instructions for placing webpage objects on said display, said browser:
selects a field of the interlaced display to display selected horizontal edges of said plurality of objects;
analyzes each one of said plurality of objects to determine which object have said selected horizontal edges that can all be placed on the selected field unmodified and which object have said selected horizontal edges that cannot all be placed on the selected field;
places said selected horizontal edges of said plurality of objects, which have said selected horizontal edges that can all be placed on said selected field unmodified, in said webpage on said selected field; and
modifies each one of said plurality objects, which have said selected horizontal edges that cannot all be placed on said selected field whereby the flicker is reduced.

28. The computer system in claim 27, wherein the said browser further:
changes the placement of one or more of said selected horizontal edges of the object that cannot be placed on said selected field, so that all of said selected horizontal edges can be placed on the said selected field; and
places all of the said selected horizontal edges of said object in said webpage on said selected field.

29. The computer system in claim 27, wherein the said browser further:
modifies a luminance intensity of each one of said selected horizontal edges of the object that cannot be placed on the selected field;
places said selected horizontal edges of said object that has not been modified in said webpage on said selected field; and
places said selected horizontal edges of said object with modified luminance intensity in said webpage on the other field of the interlaced display.

30. The computer system in claim 27, wherein the said browser further
applies a flicker reduction filter to reduce the flicker of the object; and
places the filtered object in the webpage on the interlaced display.

31. The computer system in claim 27, wherein said selected horizontal edges includes baseline of text.

32. The computer system in claim 27, wherein said selected horizontal edges includes underline of text.

33. The computer system in claim 27, wherein said height attributes includes a height between baseline and top of text.

34. The computer system in claim 27, wherein the said browser further selects a horizontal edge of the object if the horizontal edge is darker than the background luminous intensity.

35. The computer system in claim 27, wherein the said browser further places the horizontal edges of the objects that are lighter than the background luminous intensity to the other field of the interlaced display devise.

36. For a computer system having a display of two interlaced fields, software for handling the display of webpage on said display, said software comprising:
code for selecting a field of said display to display selected horizontal edges of said plurality of objects;
code for analyzing each one of said plurality objects to determine if the object has one or more height attributes;
code for determining a number of lines for each one of said one or more height attributes;
code for modifying said number of lines to an odd number if said number of lines is even; and
code for placing said selected horizontal edges of said objects that have said one or more height attribute in said webpage on the selected field whereby flicker is reduced.

37. For a computer system having a display of two interlaced fields, software for handling the display of webpage on said display, said software comprising:
code for selecting a field of said display to display selected horizontal edges of said plurality of objects;
code for analyzing each one of said plurality of objects to determine which object have said selected horizontal edges that can all be placed on the selected field unmodified and which object have said selected horizontal edges that cannot all be placed on the selected field;
code for placing said selected horizontal edges of said plurality of objects, which have said selected horizontal edges that can all be placed on said selected field unmodified, in said webpage on said selected field; and
code for modifying each of said plurality of objects, which have said selected horizontal edges that cannot all be placed on said selected field, so that the flicker is reduced.
